(19) United States
(12) Patent Application Publication
(10) Pub. No.: US 2016/0314250 A1
(43) Pub. Date: Oct. 27, 2016

(54) Your Lifelink

(71) Applicant: Dawn Abel, Groundbirch (CA)

(72) Inventor: Dawn Abel, Groundbirch (CA)

(21) Appl. No.: 14/695,050

(22) Filed: Apr. 24, 2015

(51) Int. Cl. G06F 19/00

(52) U.S. Cl. CPC G06F 19/323

(57) ABSTRACT

A medical information application that is installed on a mobile device and is carried by a user has their up to date medical information so that it can be accessed at the time of an emergency. The application can be accessed easily by the medical practitioner and/or other person, even if the mobile device is locked by a security password. The application is clearly recognizable as an indicator of personal medical information on the display scream of mobile device. The application is also useful in finding lost devices. The medical information application can be installed in devices other than mobile devices, including tablets, MP3 players, laptops, computers, etc.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of the Invention

The present invention relates generally to cellular phone technology. Specifically, this invention relates to a medical information application whereby an individual can carry their medical information on a mobile phone via this app. More particularly, the present invention is related to a medical information application that includes a device that is carried by a user that has their up to date medical information so that it can be accessed at the time of an emergency.

(2) Background of Invention

In many accident cases, it is found that the injured person either does not carry current emergency medical information, or that the emergency personnel cannot locate the information. This situation is caused by the fact that emergency instructions that people carry are often not readily accessible. As a result, an injured person risks receiving inappropriate, or even dangerous, medical treatment.

There have been various proposals for supplying personal medical information on a personal object to be worn at all times, such as on a piece of jewelry, a medal, etc, perhaps in combination with a symbol to attract attention and/or an inscription showing the individual's identity. However, all of these objects have disadvantages and shortcomings, which have discouraged their widespread use.

In order for such an information system to be reliable and effective, it must be widely used and well known to emergency workers responding to accidents. To become well known, the objects storing the medical information must be worn by many people; that is, they must meet criteria such as convenience, effectiveness, appearance, and cost. The objects must be clearly recognizable as indicators of personal medical information; however since the information is confidential, it should not be visible when the object is worn.

Accordingly, the current invention seeks to create a mobile application that effectively and efficiently alleviates the aforementioned problems.

The present invention addresses the above described need by providing a medical information application that is conveniently installed on the individual's mobile device so that it can be accessed in the event of an emergency.

As such, may be appreciated that there continues to be a need for a new and improved mobile application, as set forth by the present invention, that addresses the problems of ease of use as well as effectiveness in construction in providing this unique concept to the cellular phone technology. In this respect, the present invention substantially fulfills this need.

### BRIEF SUMMARY OF THE INVENTION

In view of the foregoing disadvantages inherent in the known types of the mobile applications now present in the prior art, the present invention provides a mobile application wherein the cellular phone technology provides a medical information application, whereby an individual can carry their medical information on a mobile phone via this app, and also use this application with the process of the various components employed in the procedure. As such, the general purpose of the present invention, which will be described subsequently in greater detail, is to provide a new and improved mobile application for providing medical information that has all of the advantages of the prior art, and none of the disadvantages.

Accordingly, it is a primary objective of the present invention to provide a medical information application that is installed on a mobile device that is carried by a user. The application has all of their up to date medical information so that it can be accessed at the time of an emergency.

In another aspect, the present invention provides an application where the owner can put his emergency contact information, including contact number(s), past medical issues and treatments, and the like.

It is yet another objective of the present invention to provide an application that can be accessed even when the phone is locked by the owner.

It is a further aspect of the present invention to provide an application that is clearly recognizable as an indicator of personal medical information.

Still another objective of the present invention is to provide a system that updates the medical information on the application server from various sources, including hospitals, doctors' offices, and medical laboratories and testing centers.

Additionally, the application is also helpful finding lost mobile devices.

A further aspect of the present invention allows the convenient usage of the provided application.

Other aspects of the present invention will become apparent, from time to time, throughout the specification, as hereinafter related.

In this respect, before explaining at least one embodiment of the invention in detail, it is to be understood that the invention is not limited in its application to the details of construction and to the arrangements of the components set forth in the following description. The invention is capable of other embodiments, and of in being practiced and carried out in various ways. Also, it is to be understood that the phraseology and terminology employed herein are for the purpose of description, and should not be regarded as limiting.

These, together with other aspects of the invention and the various features of novelty that characterize the invention, are pointed out with particularity in the disclosure. For a better understanding of the invention, its operating advantages, and the specific objectives attained by its uses, reference should be had to the descriptive matter, in which there are illustrated preferred embodiments of the invention.

### DETAILED DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations are set forth in order to provide a thorough understanding of the illustrative embodiments. However, it will be apparent to one skilled in the art that the present invention may be practiced without the specific details. In other instances, well-known features are omitted or simplified in order to not obscure the illustrative embodiments.

The description that follows includes exemplary devices, methods, memory, systems, techniques, instruction sequences, and computer program products that embody techniques of the present inventive subject matter. However, it should be understood that the described embodiments may be practiced without these in specific details. Well-known instruction instances, protocols, structures, and techniques have not been shown in detail in order to not obfuscate the description.

The inventive subject matter includes devices, methods, memory, and systems that utilize cellular phone technology. The technology can be used in conjunction with mobile devices, or other electronic devices. This allows the is application to utilize and sustain the advancement in the field of cellular phone technology at the time of an emergency.

The terms user, owner, and victim are used throughout this disclosure, and are intended to refer to the same person with respect to a mobile phone. The term victim is applied to describe situations where the owner/user of the mobile phone has suffered an injury or illness that requires emergency medical attention.

In some preferred embodiments, the present invention provides a medical information application that is installed in the individual's mobile device so that it can be accessed at the time of an emergency. To accomplish the task, the mobile phone includes a software application that stores personal medical information. A user interface is built to access and manipulate the application and the personal medical information. The user interface includes a means for inputting data into the mobile phone under the direction of the present application, as well as a means to display the personal medical information on the mobile phone's display.

In another embodiment, the present mobile application is accessible by the medical practitioner or other individual present at the time of injury or accident on the victim's mobile phone, even when the victim's mobile phone is locked securely by the password. The application is clearly recognizable as indicators of personal medical information at the first display of the victim's mobile phone. This arrangement will work in most instances, even when the victim is unable to provide the password due to unconsciousness or other disabling condition.

A further embodiment discloses another feature, which is provided by the provision for storing medical information in the software application. The medical information capable ole being stored on the mobile phone includes, but is not limited to, emergency contact information current medications and dosages, blood type, age, names of doctors with their respective, contact numbers, and information related to their medical history. This information can be presented in a variety of ways. For instance, there can be a top level menu item for medical data. Under this item can be several sub-items for contact names, doctor names, medications, vital statistics (e.g., blood type), medical conditions (e.g. diabetes), and family medical history. Selecting any of these items will cause the mobile phone to display the data tied to that selection. If appropriate, further sub-menu items can provide further detail on a particular topic.

In accordance with the invention, the person available at the time of emergency can easily access the required information, therefore providing the best help to the victim. It should be noted that the present invention is very helpful in accordance with the above mentioned embodiments, as the person can easily carry and quickly access the mobile phone without any hassle.

In addition to being a helping hand in emergency situation, the application is also beneficial to the user in finding their lost devices. The application is intended with the feature to alert the person about the lost device, to whom the device belongs, so that it can be returned safely to the owner.

As may be appreciated from the above description, the present invention provides a medical information application that may be accessed by the individual in the victim's device. The device is not limited to mobile phones, but can be other interactive electronic devices as well, such as tablets, MP3 players, laptops, computers, etc.

It is to be understood that the above description is intended to be illustrative, and not restrictive. For example, the above-discussed embodiments may be used in combination with each other. Many other embodiments will be apparent to is those of skill in the art upon reviewing the above description.

While the invention has been illustratively described in its preferred form, it is not intended to limit the scope of the invention that follow to the specifics of that design form, in as much as variations equivalent thereto are feasible without departing from the novel inventive concepts involved. Plural instances may be provided for components, operations, or structures that are described herein as a single instance. Finally, boundaries between various components and operations are somewhat arbitrary, and particular operations are illustrated in the context of specific illustrative configurations.

Other allocations of functionality are envisioned, and may fall within the scope of the inventive subject matter. In general, structures and functionality presented as separate components the exemplary configurations may be implemented as a combined structure or component. Similarly, structures and functionality presented as a single component may be implemented as separate components. These and other variations, modifications, additions, and improvements may fall within the scope of the inventive subject matter.

1. A medical inform at mobile device having updated owner's medical information accessible at the time of an emergency comprises:
a) software application for storage and access personal medical information,
b) a mobile device for installation of said software applications; and
c) user interface for accessing and manipulating said software application and personal medical information.

2. The medical information application of claim 1, wherein said medical information comprising, emergency contact information, current medications and dosages, blood type, age, names of doctors with their respective contact numbers, and information related to their medical history.

3. The medical information application of claim 1, wherein said application accessible by other persons without a password in locked status of said mobile device.

4. The medical information application of claim 1, wherein said application is clearly displayed on the screen of said mobile device.

5. The medical information application of claim 1, wherein said application determining the current position of said mobile device.

6. The medical information application of claim 1, wherein said application installed in devices selecting of the group consisting of mobile phones, tablets, MP3 players, laptops, and computers.
